(19) United States
(12) Patent Application Publication
(10) Pub. No.: US 2022/0107287 A1
(43) Pub. Date: Apr. 7, 2022

(54) SENSOR ELEMENT AND GAS SENSOR

(71) Applicant: NGK Insulators, Ltd., Nagoya-shi (JP)

(72) Inventors: Taku OKAMOTO, Nagoya-shi (JP); Yuichiro KONDO, Nagoya-shi (JP)

(21) Appl. No.: 17/487,021

(22) Filed: Sep. 28, 2021

(30) Foreign Application Priority Data
Oct. 2, 2020 (JP) 2020-167844

(51) Int. Cl. G01N 27/407; G01N 27/419; G01N 27/409

(52) U.S. Cl. CPC G01N 27/4072; G01N 27/4077; G01N 27/409; G01N 27/419

(57) ABSTRACT

Provided is a sensor element and a gas sensor capable of suppressing a disadvantage resulting from the structure of a diffusion control unit while suppressing the influence of a dynamic pressure resulting from an operation of an engine. A sensor element is used to measure the concentration of a predetermined gas component in a measurement target gas. The sensor element includes an oxygen ion-conductive solid electrolyte. A gas introduction opening is formed at one end portion in the long side direction of the sensor element. An internal cavity is formed inside the sensor element. A diffusion control unit is formed between the gas introduction opening and the internal cavity. The diffusion control unit includes first and second diffusion control units that are arranged along the long side direction. The first diffusion control unit includes a first opening portion. The second diffusion control unit includes a second opening portion.

### CROSS-REFERENCE TO RELATED APPLICATION

The present application claims priority from Japanese application JP 2020-167844, filed on Oct. 2, 2020, the contents of which is hereby incorporated by reference into this application.

### TECHNICAL FIELD

The present invention relates to a sensor element and a gas sensor.

### BACKGROUND ART

Japanese Patent No. 3701124 discloses a gas sensor.

This gas sensor is configured to measure the NOx concentration in a measurement target gas. This gas sensor includes a sensor element, and a main component of the sensor element is an oxygen ion-conductive solid electrolyte.

In this sensor element, a first cavity configured to introduce a measurement target gas from the external space via a diffusion control unit, and a second cavity connected to the first cavity are formed. A detection electrode for use in measurement of the NOx concentration is formed inside the second cavity. In the gas sensor, the oxygen concentration in the first cavity is adjusted by a main pump cell including an internal pump electrode formed inside the first cavity and an external pump electrode formed outside the first cavity.

That is to say, in this gas sensor, a measurement target gas whose oxygen partial pressure is kept low is supplied to the detection electrode, and the NOx concentration is measured based on the measurement target gas (see Japanese Patent No. 3701124).

Japanese Patent No. 3701124 is an example of related art.

Gas sensors including sensor elements are attached to, for example, an exhaust pipe of an engine. Thus, sensor elements are influenced by a dynamic pressure resulting from an operation of an engine. In the sensor element disclosed in Japanese Patent No. 3701124, the influence of a dynamic pressure is suppressed by refining the structure of a diffusion control unit. However, such a structure capable of effectively suppressing the influence of a dynamic pressure is also disadvantageous.

### SUMMARY OF THE INVENTION

The present invention was made in order to solve the above-described problems, and it is an object thereof to provide a sensor element and a gas sensor capable of suppressing a disadvantage resulting from the structure of a diffusion control unit while suppressing the influence of a dynamic pressure resulting from an operation of an engine.

A sensor element according to an aspect of the present invention is used to measure the concentration of a predetermined gas component in a measurement target gas. The sensor element includes an oxygen ion-conductive solid electrolyte. The sensor element has a long side and a short side in a plan view. A gas introduction opening for capturing the measurement target gas from an external space of the sensor element into the sensor element is formed at one end portion in the long side direction of the sensor element. An internal cavity into which the measurement target gas introduced via the gas introduction opening is introduced is formed inside the sensor element. A diffusion control unit is formed between the gas introduction opening and the internal cavity. The diffusion control unit includes first and second diffusion control units that are arranged along the long side direction. The first diffusion control unit includes a first opening portion. The second diffusion control unit includes a second opening portion. The sum of a value obtained by dividing a product of an outer peripheral length of the first opening portion and a length in the long side direction of the first opening portion, by a cross-sectional area of the first opening portion, and a value obtained by dividing a product of an outer peripheral length of the second opening portion and a length in the long side direction of the second opening portion, by a cross-sectional area of the second opening portion, is 75 or more.

The inventor (s) of the present invention found that, if the sum of a value obtained by dividing a product of an outer peripheral length of the first opening portion and a length in the long side direction of the first opening portion, by a cross-sectional area of the first opening portion, and a value obtained by dividing a product of an outer peripheral length of the second opening portion and a length in the long side direction of the second opening portion, by a cross-sectional area of the second opening portion, is 75 or more, the influence of a dynamic pressure resulting from an operation of an engine in the sensor element can be suppressed regardless of the shapes of the first and second opening portion. In the sensor element according to the present invention, the sum of a value obtained by dividing a product of an outer peripheral length of the first opening portion and a length in the long side direction of the first opening portion, by a cross-sectional area of the first opening portion, and a value obtained by dividing a product of an outer peripheral length of the second opening portion and a length in the long side direction of the second opening portion, by a cross-sectional area of the second opening portion, is 75 or more. Thus, according to this sensor element, the influence of a dynamic pressure resulting from an operation of an engine can be suppressed regardless of the shapes of the first and second opening portions. That is to say, according to this sensor element, it is possible to suppress another disadvantage that may be caused by the structures of the first and second diffusion control units, while suppressing the influence of a dynamic pressure resulting from an operation of an engine, by refining the shapes of the first and second opening portions.

The sensor element may include a pump cell, the pump cell may include an internal pump electrode formed inside the internal cavity, and an external pump electrode formed in a space different from the internal cavity, and the pump cell may be configured to pump out oxygen in the internal cavity, by applying a voltage to a point between the internal pump electrode and the external pump electrode.

In the sensor element, the sum may be 180 or less.

In the sensor element, a shape of the first opening portion and a shape of the second opening portion may be different from each other.

The diffusion control units may have various shapes. The inventor (s) of the present invention found that advantages and disadvantages vary depending on the shapes of the diffusion control units. In the sensor element according to the present invention, the shape of the first opening portion and the shape of the second opening portion are different from each other. That is to say, according to this sensor element, it is possible to satisfy required specifications of the sensor element by determining the shapes of the first opening portion and the second opening portion in consideration of advantages and disadvantages derived from each shape.

In the sensor element, one of the first and second opening portions may be constituted by two slits that are arranged along a thickness direction of the sensor element, another of the first and second opening portions may be constituted by a hole extending in the long side direction, and a proportion of a length in the short side direction of the hole to a length in the thickness direction of the hole may be 0.3 or more and 2.0 or less.

The structure including two slits that are arranged along the thickness direction of the sensor element (also referred to as a “slit structure”) is more advantageous than the structure including a hole extending in the long side direction (also referred to as a “punched structure”), for example, from the viewpoint of suppressing the influence of a dynamic pressure resulting from an operation of an engine. Meanwhile, the punched structure can be realized, for example, through punching using a die, and thus it is more advantageous than the slit structure from the viewpoint of suppressing a manufacture variation. Furthermore, since sensor elements are typically heated by a heater and the punched structure includes a smaller number of air layers (with a low thermal conductivity), and thus the punched structure is more advantageous than the slit structure from the viewpoint of the heating efficiency using a heater. In the sensor element according to the present invention, one of the first and second opening portions includes a hole extending in the long side direction, and the other of the first and second opening portions includes two slits that are arranged along the thickness direction of the sensor element. Thus, according to this sensor element, it is possible to achieve advantages of both of the slit structure and the punched structure.

In the sensor element, a value obtained by dividing the product of the outer peripheral length of the first opening portion and the length in the long side direction of the first opening portion, by the product of the outer peripheral length of the second opening portion and the length in the long side direction of the second opening portion, may be larger than 10 or smaller than 0.1.

That is to say, in this sensor element, the shape of the first opening portion and the shape of the second opening portion are significantly different from each other. Thus, according to this sensor element, it is possible to achieve advantages of the respective shapes of the first and second opening portions.

A gas sensor according to another aspect of the present invention includes the above-described sensor element.

According to the present invention, it is possible to provide a sensor element and a gas sensor capable of suppressing a disadvantage resulting from the structure of a diffusion control unit while suppressing the dependence on a dynamic pressure of an engine.

### BRIEF DESCRIPTION OF THE DRAWINGS

FIG. 1 is a cross-sectional schematic view schematically showing an example of the configuration of a gas sensor.

FIG. 2 is a view schematically showing part of a plane of the gas sensor.

FIG. 3 is a view schematically showing a cross-section taken along III-III in FIG. 2.

FIG. 4 is a view schematically showing a cross-section taken along IV-IV in FIG. 2.

FIG. 5 is a cross-sectional schematic view schematically showing an example of the configuration of a gas sensor including a sensor element with a three-cavity structure.

FIG. 6 is a view schematically showing a cross-section of a sensor element according to a first modified example.

FIG. 7 is a view schematically showing a cross-section of a sensor element according to a second modified example.

FIG. 8 is a view schematically showing a cross-section of a sensor element according to a third modified example.

FIG. 9 is a view schematically showing a cross-section of a sensor element according to a fourth modified example.

FIG. 10 is a view illustrating a method for measuring the dynamic pressure.

FIG. 11 is a graph schematically showing a state of a dynamic pressure resulting from an operation of an engine.

FIG. 12 is a graph schematically showing a change in output Ip0 of the gas sensor.

FIG. 13 is a graph showing change rates of Ip0 in Examples 1 to 4 and Comparative Example.

FIG. 14 is a graph showing slopes of straight lines in FIG. 13.

### EMBODIMENTS OF THE INVENTION

Hereinafter, an embodiment of the present invention will be described in detail with reference to the drawings. Note that the same or corresponding constituent elements in the drawings are denoted by the same reference numerals and a description thereof will not be repeated.

### 1. Schematic Configuration of Gas Sensor

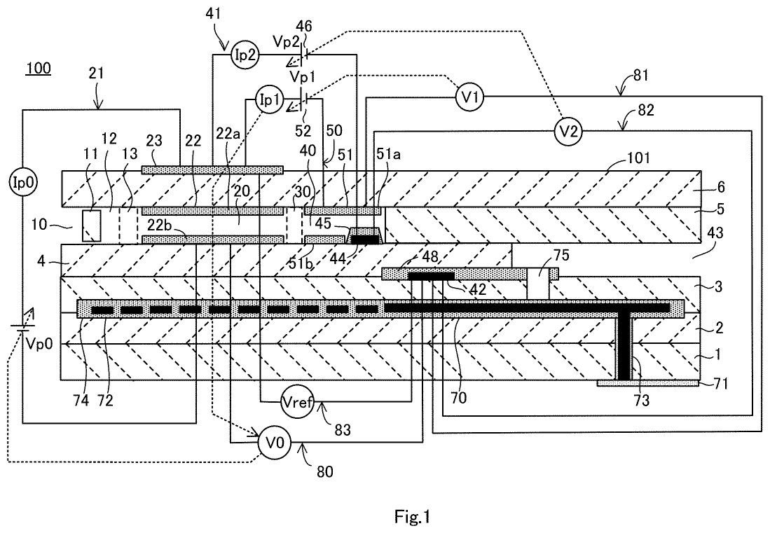

FIG. 1 is a cross-sectional schematic view schematically showing an example of the configuration of a gas sensor 100. The sensor element 101 is an element having a structure in which six layers consisting of a first substrate layer 1, a second substrate layer 2, a third substrate layer 3, a first solid electrolyte layer 4, a spacer layer 5, and a second solid electrolyte layer 6 are stacked in this order from the lower side in the drawing, the layers being each constituted by an oxygen ion-conductive solid electrolyte layer made of zirconia (ZrO₂) or the like. Furthermore, the solid electrolyte forming these six layers is a dense and airtight material. The sensor element 101 with this configuration is produced, for example, by performing predetermined processing and printing of circuit patterns on ceramic green sheets corresponding to the respective layers, stacking the resultant layers, and integrating them through firing.

In the front end portion of the sensor element 101, a gas introduction opening 10, a first diffusion control unit 11, a buffer space 12, a second diffusion control unit 13, a first internal cavity 20, a third diffusion control unit 30, and a second internal cavity 40 are arranged in this order adjacent to each other in a connected manner between the lower face of the second solid electrolyte layer 6 and the upper face of the first solid electrolyte layer 4.

The gas introduction opening 10, the buffer space 12, the first internal cavity 20, and the second internal cavity 40 are spaces inside the sensor element 101, the spaces being each formed by cutting out the spacer layer 5, and each having an upper portion defined by the lower face of the second solid electrolyte layer 6, a lower portion defined by the upper face of the first solid electrolyte layer 4, and side portions defined by the side faces of the spacer layer 5.

The first diffusion control unit 11 is provided as two laterally long slits (whose openings have the long side direction perpendicular to the section of the diagram). Furthermore, the second diffusion control unit 13 and the third diffusion control unit 30 are each provided as a hole whose length in the direction perpendicular to the section of the diagram is shorter than that of the first internal cavity 20 and the second internal cavity 40. Note that the region from the gas introduction opening 10 to the second internal cavity 40 is also referred to as a gas flow passage.

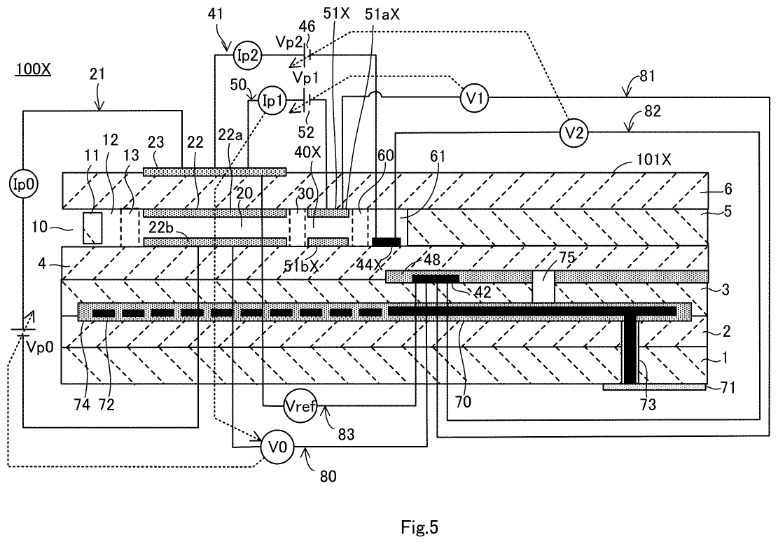

Furthermore, a reference gas introduction space 43 having side portions defined by the side faces of the first solid electrolyte layer 4 is provided between the upper face of the third substrate layer 3 and the lower face of the spacer layer 5, at a position that is farther from the front side than the gas flow passage is. For example, air is introduced into the reference gas introduction space 43. It is also possible that the first solid electrolyte layer 4 extends to the rear end of the sensor element 101, and the reference gas introduction space 43 is not formed. Furthermore, if the reference gas introduction space 43 is not formed, an air introduction layer 48 may extend to the rear end of the sensor element 101 (see FIG. 5, for example).

The air introduction layer 48 is a layer made of porous alumina, and reference gas is introduced into the air introduction layer 48 via the reference gas introduction space 43. Furthermore, the air introduction layer 48 is formed so as to cover a reference electrode 42.

The reference electrode 42 is an electrode formed so as to be held between the upper face of the third substrate layer 3 and the first solid electrolyte layer 4, and, as described above, is covered by the air introduction layer 48 that is continuous with the reference gas introduction space 43. Furthermore, as will be described later, it is possible to measure the oxygen concentration (oxygen partial pressure) in the first internal cavity 20 or the second internal cavity 40, using the reference electrode 42.

In the gas flow passage, the gas introduction opening 10 is a region that is open to the external space, and a measurement target gas is introduced from the external space via the gas introduction opening 10 into the sensor element 101.

The first diffusion control unit 11 is a region that applies a predetermined diffusion resistance to the measurement target gas introduced from the gas introduction opening 10.

The buffer space 12 is a space that is provided in order to guide the measurement target gas introduced from the first diffusion control unit 11 to the second diffusion control unit 13.

The second diffusion control unit 13 is a region that applies a predetermined diffusion resistance to the measurement target gas introduced from the buffer space 12 into the first internal cavity 20.

When the measurement target gas is introduced from the outside of the sensor element 101 into the first internal cavity 20, the measurement target gas abruptly introduced from the gas introduction opening 10 into the sensor element 101 due to a change in the pressure of the measurement target gas in the external space (a pulsation of the exhaust pressure in the case in which the measurement target gas is exhaust gas of an automobile) is not directly introduced into the first internal cavity 20, but is introduced into the first internal cavity 20 after passing through the first diffusion control unit 11, the buffer space 12, and the second diffusion control unit 13 where a change in the concentration of the measurement target gas is canceled. Accordingly, a change in the concentration of the measurement target gas introduced into the first internal cavity is reduced to be almost negligible.

The first internal cavity 20 is provided as a space for adjusting the oxygen partial pressure in the measurement target gas introduced via the second diffusion control unit 13. The oxygen partial pressure is adjusted through an operation of a main pump cell 21.

The main pump cell 21 is an electro-chemical pump cell constituted by an internal pump electrode 22 having a ceiling electrode portion 22a provided over substantially the entire lower face of the second solid electrolyte layer 6 that faces the first internal cavity 20, an external pump electrode 23 provided so as to be exposed to the external space in the region corresponding to the ceiling electrode portion 22a on the upper face of the second solid electrolyte layer 6, and the second solid electrolyte layer 6 held between these electrodes.

The internal pump electrode 22 is formed across upper and lower solid electrolyte layers (the second solid electrolyte layer 6 and the first solid electrolyte layer 4) that define the first internal cavity 20, and the spacer layer 5 that forms side walls. Specifically, the ceiling electrode portion 22a is formed on the lower face of the second solid electrolyte layer 6 that forms the ceiling face of the first internal cavity 20, a bottom electrode portion 22b is formed on the upper face of the first solid electrolyte layer 4 that forms the bottom face, and side electrode portions (not shown) that connect the ceiling electrode portion 22a and the bottom electrode portion 22b are formed on side wall faces (inner faces) of the spacer layer 5 that form two side wall portions of the first internal cavity 20, so that the entire structure is arranged in the form of a tunnel at the region in which the side electrode portions are arranged.

The internal pump electrode 22 and the external pump electrode 23 are formed as porous cermet electrodes (e.g., cermet electrodes of Pt and ZrO₂ containing 1% of Au). Note that the internal pump electrode 22 with which the measurement target gas is brought into contact is made of a material that has a lowered capability of reducing a nitrogen oxide (NOx) component in the measurement target gas.

The main pump cell 21 can apply a desired pump voltage Vp0 to a point between the internal pump electrode 22 and the external pump electrode 23, thereby causing a pump current Ip0 to flow in the positive direction or the negative direction between the internal pump electrode 22 and the external pump electrode 23, so that oxygen in the first internal cavity 20 is pumped out to the external space or oxygen in the external space is pumped into the first internal cavity 20.

Furthermore, in order to detect the oxygen concentration (oxygen partial pressure) in the atmosphere in the first internal cavity 20, the internal pump electrode 22, the second solid electrolyte layer 6, the spacer layer 5, the first solid electrolyte layer 4, the third substrate layer 3, and the reference electrode 42 constitute an electro-chemical sensor cell, that is, a main pump-controlling oxygen partial pressure detection sensor cell 80.

It is possible to see the oxygen concentration (oxygen partial pressure) in the first internal cavity 20 by measuring an electromotive force V0 in the main pump-controlling oxygen partial pressure detection sensor cell 80. Furthermore, the pump current Ip0 is controlled by performing feedback control on Vp0 such that the electromotive force V0 is kept constant. Accordingly, the oxygen concentration in the first internal cavity 20 can be kept at a predetermined constant value.

The third diffusion control unit 30 is a region that applies a predetermined diffusion resistance to the measurement target gas whose oxygen concentration (oxygen partial pressure) has been controlled through an operation of the main pump cell 21 in the first internal cavity 20, thereby guiding the measurement target gas to the second internal cavity 40.

The second internal cavity 40 is provided as a space for performing processing regarding measurement of the concentration of nitrogen oxide in the measurement target gas introduced via the third diffusion control unit 30. The NOx concentration is measured mainly in the second internal cavity 40 whose oxygen concentration has been adjusted by an auxiliary pump cell 50, through an operation of a measurement pump cell 41.

In the second internal cavity 40, the measurement target gas subjected to adjustment of the oxygen concentration (oxygen partial pressure) in advance in the first internal cavity 20 and then introduced via the third diffusion control unit is further subjected to adjustment of the oxygen partial pressure by the auxiliary pump cell 50. Accordingly, the oxygen concentration in the second internal cavity 40 can be precisely kept at a constant value, and thus the gas sensor 100 can measure the NOx concentration with a high level of precision.

The auxiliary pump cell 50 is an auxiliary electro-chemical pump cell constituted by an auxiliary pump electrode 51 having a ceiling electrode portion 51a provided on substantially the entire lower face of the second solid electrolyte layer 6 that faces the second internal cavity 40, the external pump electrode 23 (which is not limited to the external pump electrode 23, and may be any appropriate electrode outside the sensor element 101), and the second solid electrolyte layer 6.

The auxiliary pump electrode 51 with this configuration is arranged inside the second internal cavity 40 in the form of a tunnel as with the above-described internal pump electrode 22 arranged inside the first internal cavity 20. That is to say, the ceiling electrode portion 51a is formed on the second solid electrolyte layer 6 that forms the ceiling face of the second internal cavity 40, a bottom electrode portion 51b is formed on the first solid electrolyte layer 4 that forms the bottom face of the second internal cavity 40, and side electrode portions (not shown) that connect the ceiling electrode portion 51a and the bottom electrode portion 51b are formed on two wall faces of the spacer layer 5 that form side walls of the second internal cavity 40, so that the entire structure is arranged in the form of a tunnel.

Note that the auxiliary pump electrode 51 is also made of a material that has a lowered capability of reducing a nitrogen oxide component in the measurement target gas, as with the internal pump electrode 22.

The auxiliary pump cell 50 can apply a desired voltage Vp1 to a point between the auxiliary pump electrode 51 and the external pump electrode 23, so that oxygen in the atmosphere in the second internal cavity 40 is pumped out to the external space or oxygen in the external space is pumped into the second internal cavity 40.

Furthermore, in order to control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electro-chemical sensor cell, that is, an auxiliary pump-controlling oxygen partial pressure detection sensor cell 81.

Note that the auxiliary pump cell 50 performs pumping using a variable power source 52 whose voltage is controlled based on an electromotive force V1 detected by the auxiliary pump-controlling oxygen partial pressure detection sensor cell 81. Accordingly, the oxygen partial pressure in the atmosphere in the second internal cavity 40 is controlled to be a partial pressure that is low enough to not substantially affect the NOx measurement.

Furthermore, a pump current Ip1 is used to control the electromotive force of the main pump-controlling oxygen partial pressure detection sensor cell 80. Specifically, the pump current Ip1 is input as a control signal to the main pump-controlling oxygen partial pressure detection sensor cell 80, and the electromotive force V0 is controlled such that a gradient of the oxygen partial pressure in the measurement target gas that is introduced from the third diffusion control unit 30 into the second internal cavity 40 is always kept constant. When the sensor is used as an NOx sensor, the oxygen concentration in the second internal cavity 40 is kept at a constant value that is about 0.001 ppm through an operation of the main pump cell 21 and the auxiliary pump cell 50.

The measurement pump cell 41 measures the nitrogen oxide concentration in the measurement target gas, in the second internal cavity 40. The measurement pump cell 41 is an electro-chemical pump cell constituted by a measurement electrode 44 spaced away from the third diffusion control unit 30, on the upper face of the first solid electrolyte layer 4 that faces the second internal cavity 40, the external pump electrode 23, the second solid electrolyte layer 6, the spacer layer 5, and the first solid electrolyte layer 4.

The measurement electrode 44 is a porous cermet electrode. The measurement electrode 44 functions also as an NOx reduction catalyst for reducing NOx that is present in the atmosphere in the second internal cavity 40. Furthermore, the measurement electrode 44 is covered by a fourth diffusion control unit 45.

The fourth diffusion control unit 45 is a membrane constituted by a porous member mainly made of alumina (Al₂O₃). The fourth diffusion control unit 45 serves to limit the amount of NOx flowing into the measurement electrode 44, and also functions as a protective membrane of the measurement electrode 44.

The measurement pump cell 41 can pump out oxygen generated through degradation of nitrogen oxide in the atmosphere around the measurement electrode 44, and detect the generated amount as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute an electro-chemical sensor cell, that is, a measurement pump-controlling oxygen partial pressure detection sensor cell 82. A variable power source 46 is controlled based on an electromotive force V2 detected by the measurement pump-controlling oxygen partial pressure detection sensor cell 82.

The measurement target gas guided into the second internal cavity 40 passes through the fourth diffusion control unit 45 and reaches the measurement electrode 44 in a state in which the oxygen partial pressure is controlled. Nitrogen oxide in the measurement target gas around the measurement electrode 44 is reduced to generate oxygen (2NO→N₂+O₂). The generated oxygen is pumped by the measurement pump cell 41, and, at that time, a voltage Vp2 of the variable power source is controlled such that a control voltage V2 detected by the measurement pump-controlling oxygen partial pressure detection sensor cell 82 is kept constant. The amount of oxygen generated around the measurement electrode 44 is proportional to the concentration of nitrogen oxide in the measurement target gas, and thus it is possible to calculate the concentration of nitrogen oxide in the measurement target gas, using the pump current Ip2 in the measurement pump cell 41.

Furthermore, if the measurement electrode 44, the first solid electrolyte layer 4, the third substrate layer 3, and the reference electrode 42 are combined to constitute an oxygen partial pressure detection means as an electro-chemical sensor cell, it is possible to detect an electromotive force that corresponds to a difference between the amount of oxygen generated through reduction of an NOx component in the atmosphere around the measurement electrode 44 and the amount of oxygen contained in reference air can be detected, and thus it is also possible to obtain the concentration of the nitrogen oxide component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83, and it is possible to detect the oxygen partial pressure in the measurement target gas outside the sensor, based on an electromotive force Vref obtained by the sensor cell 83.

In the gas sensor 100 with this configuration, when the main pump cell 21 and the auxiliary pump cell 50 operate, the measurement target gas whose oxygen partial pressure is always kept at a constant low value (a value that does not substantially affect the NOx measurement) is supplied to the measurement pump cell 41. Accordingly, it is possible to see the nitrogen oxide concentration in the measurement target gas, based on the pump current Ip2 that flows when oxygen generated through reduction of NOx is pumped out by the measurement pump cell 41, substantially in proportion to the concentration of nitrogen oxide in the measurement target gas.

Furthermore, in order to improve the oxygen ion conductivity of the solid electrolyte, the sensor element 101 includes a heater unit 70 that serves to adjust the temperature of the sensor element 101 through heating and heat retention. The heater unit 70 includes a heater electrode 71, a heater 72, a through-hole 73, a heater insulating layer 74, and a pressure dispersing hole 75.

The heater electrode 71 is an electrode formed so as to be in contact with the lower face of the first substrate layer 1. When the heater electrode 71 is connected to an external power source, electricity can be supplied from the outside to the heater unit 70.

The heater 72 is an electrical resistor formed so as to be held between the second substrate layer 2 and the third substrate layer 3 from above and below. The heater 72 is connected via the through-hole 73 to the heater electrode 71, and, when electricity is supplied from the outside via the heater electrode 71, the heater 72 generates heat, thereby heating and keeping the temperature of a solid electrolyte constituting the sensor element 101.

Furthermore, the heater 72 is embedded over the entire region from the first internal cavity 20 to the second internal cavity 40, and thus the entire sensor element 101 can be adjusted to a temperature at which the above-described solid electrolyte is activated.

The heater insulating layer 74 is an insulating layer constituted by an insulating member made of alumina or the like on the upper and lower faces of the heater 72. The heater insulating layer 74 is formed in order to realize the electrical insulation between the second substrate layer 2 and the heater 72 and the electrical insulation between the third substrate layer 3 and the heater 72.

The pressure dispersing hole 75 is a hole that extends through the third substrate layer 3 and is connected to the reference gas introduction space 43, and is formed in order to alleviate an increase in the internal pressure in accordance with an increase in the temperature in the heater insulating layer 74.

### 2. Shapes of Diffusion Control Units

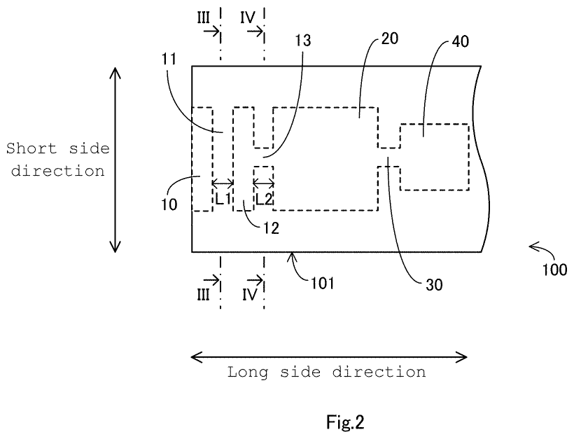

FIG. 2 is a view schematically showing part of a plane of the gas sensor 100 according to this embodiment. As shown in FIG. 2, the sensor element 101 has a long side and a short side in a plan view. The direction in which the long side of the sensor element 101 extends may be hereinafter simply referred to as a “long side direction”, and the direction in which the short side of the sensor element 101 extends may be hereinafter simply referred to as a “short side direction”.

In the sensor element 101, the gas introduction opening 10, the first diffusion control unit 11, the buffer space 12, the second diffusion control unit 13, the first internal cavity 20, the third diffusion control unit 30, and the second internal cavity 40 are sequentially arranged in the long side direction when viewed from the gas introduction opening 10 side.

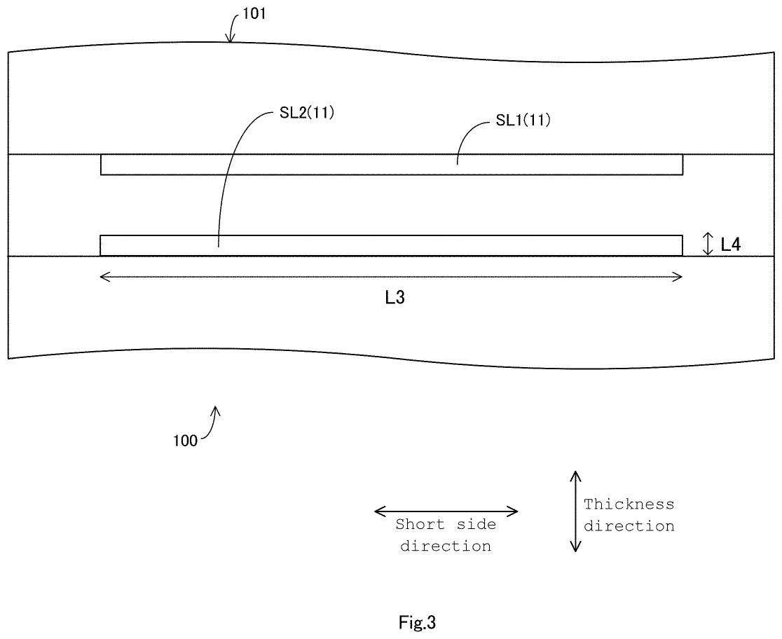

FIG. 3 is a view schematically showing a cross-section taken along III-III in FIG. 2. As shown in FIG. 3, the first diffusion control unit 11 includes an opening portion. This opening portion is constituted by slits SL1 and SL2. The slits SL1 and SL2 are arranged in the thickness direction of the sensor element 101 (which may be hereinafter simply referred to as a “thickness direction”). In each of the slits SL1 and SL2, the length in the short side direction is L3, and the length in the thickness direction is L4. The length L3 is, for example, 50 times or more and 500 times or less of the length L4. Furthermore, in each of the slits SL1 and SL2, the length in the long side direction is L1 (FIG. 2). Such a structure having at least one slit such as the slits SL1 and SL2 is also referred to as a “slit structure”.

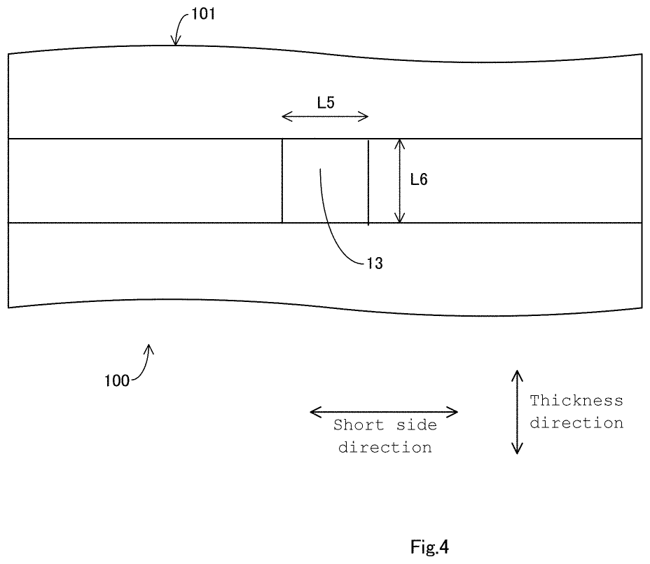

FIG. 4 is view schematically showing a cross-section taken along IV-IV in FIG. 2. Referring to FIGS. 2 and 4, the second diffusion control unit 13 includes an opening portion. This opening portion is constituted by a hole extending in the long side direction. In the second diffusion control unit 13, the length in the short side direction of the opening portion is L5, the length in the thickness direction of the opening portion is L6. In the second diffusion control unit 13, a proportion (L5/L6) of the length in the short side direction (L5) to the length in the thickness direction (L6) is 0.3 or more and 2.0 or less. Furthermore, the length in the long side direction of the hole is L2 (FIG. 2). The second diffusion control unit 13 is formed through so-called punching, which will be described later in detail. Such a structure having a hole is also referred to as a “punched structure”.

The gas sensor 100 including the sensor element 101 is attached to, for example, an exhaust pipe (not shown) of an engine. Thus, the sensor element 101 is influenced by a dynamic pressure resulting from an operation of an engine. When the sensor element 101 is significantly influenced by a dynamic pressure, the output signal of the sensor element 101 has an increased pulsation, which causes false positive. The susceptibility to a dynamic pressure is also referred to as a “the dependence on a dynamic pressure”.

The slit structure of the first diffusion control unit 11 is more advantageous than the punched structure, for example, from the viewpoint of suppressing the influence of a dynamic pressure resulting from an operation of an engine. However, the slit structure is also disadvantageous. The slit structure is formed, for example, by printing an organic material on the first solid electrolyte layer 4 and evaporating the organic material through firing. Since the slit structure is formed through such a method, it is likely to relatively have a manufacture variation. Furthermore, in the slit structure, a relatively large air layer is formed. In the slit structure, the air layer has a low thermal conductivity, and thus the heating efficiency of the sensor element 101 using the heater 72 is not high.

Meanwhile, the punched structure can be realized, for example, through punching using a die, and thus it is more advantageous than the slit structure from the viewpoint of suppressing a manufacture variation. Furthermore, the punched structure includes a smaller number of air layers (with a low thermal conductivity), and thus it is more advantageous than the slit structure from the viewpoint of the heating efficiency using a heater.

3. Relationship between Shape of Diffusion Control Unit and Dependence on Dynamic Pressure

For example, in accordance with an increase in the pressure loss in the first diffusion control unit 11 and the second diffusion control unit 13, the pulsation of a measurement target gas is suppressed more reliably, and thus the dependence on a dynamic pressure decreases. In fluid dynamics, there is Equation (1) below regarding the pressure loss. Equation (1) is a so-called Darcy-Weisbach equation.

$$Δ P = λ \frac{l}{4 m} \frac{ρ {v}^{2}}{2} \qquad ( 1 )$$

where ΔP is a pressure loss. λ is a pipe friction coefficient. l is a pipe axis length of a straight pipe with a non-circular cross-section through which a fluid flows. m is a hydraulic mean depth and is (pipe cross-sectional area)/(wetted perimeter of fluid in pipe cross-section). ρ is a density of a fluid that flows through the straight pipe with a non-circular cross-section, and v is an average flow rate of the fluid.

It is seen from Equation (1) that the pressure loss increases in accordance with an increase in the length of a pipe through which a fluid flows, increases in accordance with an increase in the wetted perimeter of a fluid in a pipe cross-section, and increases in accordance with a decrease in the pipe cross-sectional area. Note that the “wetted perimeter of a fluid in a pipe cross-section” is the outer peripheral length of the pipe cross-section.

Referring to FIGS. 3 and 4 again, each of the outer peripheral lengths of the slits SL1 and SL2 is 2L3+2L4. That is to say, in the first diffusion control unit 11, the total outer peripheral length of the opening portion is 4L3+4L4. In the second diffusion control unit 13, the outer peripheral length of the opening portion is 2L5+2L6. The cross-sectional area of the first diffusion control unit 11 is L3×L4×2 (which is referred to as 51), and the cross-sectional area of the second diffusion control unit 13 is L5×L6 (which is referred to as S2).

In the sensor element 101, the dependence of Ip0 on a dynamic pressure also has to be suppressed, and thus the dependence on a dynamic pressure has to be sufficiently suppressed by the first diffusion control unit 11 and the second diffusion control unit 13. That is to say, the value of (4L3+4L4)×L1/S1+(2L5+2L6)×L2/S2 has to be large to some extent.

The inventor (s) of the present invention found that, if the sum of a value obtained by dividing a product of an outer peripheral length (4L3+4L4) of the opening portion in the first diffusion control unit 11 and a length (L1) in the long side direction of the opening portion in the first diffusion control unit 11, by a cross-sectional area (S1) of the opening portion in the first diffusion control unit 11, and a value obtained by dividing a product of an outer peripheral length (2L5+2L6) of the opening portion in the second diffusion control unit 13 and a length (L2) in the long side direction of the opening portion in the second diffusion control unit 13, by a cross-sectional area (S2) of the opening portion in the second diffusion control unit 13, is 75 or more, the influence of a dynamic pressure resulting from an operation of an engine can be suppressed in the sensor element 101 regardless of the shapes of the respective opening portions in the first diffusion control unit 11 and the second diffusion control unit 13.

Thus, in the sensor element 101 according to this embodiment, the value of (4L3+4L4)×L1/S1+(2L5+2L6)×L2/S2 is 75 or more. Furthermore, the value of (4L3+4L4)×L1/S1+(2L5+2L6)×L2/S2 is 180 or less. Thus, according to the sensor element 101, the influence of a dynamic pressure resulting from an operation of an engine can be suppressed regardless of the shapes of the respective opening portions in the first diffusion control unit 11 and the second diffusion control unit 13. That is to say, according to the sensor element 101, it is possible to suppress another disadvantage that may be caused by the structures of the first diffusion control unit 11 and the second diffusion control unit 13, while suppressing the influence of a dynamic pressure resulting from an operation of an engine, by refining the shapes of the respective opening portions in the first diffusion control unit 11 and the second diffusion control unit 13.

Furthermore, in the sensor element 101, a value obtained by dividing a product of an outer peripheral length (4L3+4L4) of the opening portion in the first diffusion control unit 11 and a length (L1) in the long side direction of the opening portion in the first diffusion control unit 11, by an outer peripheral length (2L5+2L6) of the opening portion in the second diffusion control unit 13 and a length (L2) in the long side direction of the opening portion in the second diffusion control unit 13 is larger than 10.

That is to say, in the sensor element 101, the shape of the opening portion in the first diffusion control unit 11 and the shape of the opening portion in the second diffusion control unit 13 are significantly different from each other. Thus, according to the sensor element 101, it is possible to achieve advantages of both of the shape (slit structure) of the opening portion in the first diffusion control unit 11 and the shape (punched structure) of the opening portion in the second diffusion control unit 13.

### 4. Features

As described above, in the sensor element 101 according to this embodiment, the sum of a value obtained by dividing a product of an outer peripheral length of the opening portion in the first diffusion control unit 11 and a length in the long side direction of the opening portion in the first diffusion control unit 11, by a cross-sectional area of the opening portion in the first diffusion control unit 11, and a value obtained by dividing a product of an outer peripheral length of the opening portion in the second diffusion control unit 13 and a length in the long side direction of the opening portion in the second diffusion control unit 13, by a cross-sectional area of the opening portion in the second diffusion control unit 13, is 75 or more. Thus, according to the sensor element 101, the influence of a dynamic pressure resulting from an operation of an engine can be suppressed regardless of the shapes of the respective opening portions in the first diffusion control unit 11 and the second diffusion control unit 13. That is to say, according to the sensor element 101, it is possible to suppress another disadvantage that may be caused by the structures of the first diffusion control unit 11 and the second diffusion control unit 13, while suppressing the influence of a dynamic pressure resulting from an operation of an engine, by refining the shapes of the respective opening portions in the first diffusion control unit 11 and the second diffusion control unit 13.

Furthermore, the diffusion control units may have various shapes. As described above, the inventor(s) of the present invention found that advantages and disadvantages vary depending on the shapes of the opening portions in the first diffusion control unit 11 and the second diffusion control unit 13. In the sensor element 101, the shape of the opening portion in the first diffusion control unit 11 and the shape of the opening portion in the second diffusion control unit 13 are different from each other. That is to say, according to the sensor element 101, it is possible to satisfy required specifications of the sensor element 101 by determining the shapes of the respective opening portions in the first diffusion control unit 11 and the second diffusion control unit 13 in consideration of advantages and disadvantages derived from each shape.

Furthermore, in the sensor element 101, the opening portion in the second diffusion control unit 13 is constituted by a hole extending in the long side direction, and the opening portion in the first diffusion control unit 11 is constituted by two slits SL1 and SL2 that are arranged along the thickness direction of the sensor element 101. Thus, according to the sensor element 101, it is possible to achieve advantages of both of the slit structure and the punched structure.

### 5. Modified Examples

Although an embodiment of the present invention has been described above, the present invention is not limited to the foregoing embodiment, and various modifications can be made within the scope not departing from the gist of the invention. Hereinafter, modified examples will be described.

5-1

In the gas sensor 100 according to the foregoing embodiment, the first internal cavity 20 and the second internal cavity 40 are formed in the sensor element 101. That is to say, the sensor element 101 has a two-cavity structure. However, the sensor element 101 does not absolutely have to have a two-cavity structure. For example, it is also possible that the sensor element 101 has a three-cavity structure.

FIG. 5 is a cross-sectional schematic view schematically showing an example of the configuration of a gas sensor 100X including a sensor element 101X with a three-cavity structure. It is also possible that, as shown in FIG. 5, the second internal cavity 40 (FIG. 1) is further divided by a fifth diffusion control unit 60 into two cavities consisting of a second internal cavity 40X and a third internal cavity 61. In this case, an auxiliary pump electrode 51X may be arranged in the second internal cavity 40X, and a measurement electrode 44X may be arranged in the third internal cavity 61. In the case of applying a three-cavity structure, the fourth diffusion control unit 45 may be omitted.

5-2

In the sensor element 101 according to the foregoing embodiment, the cross-sectional shapes of the first diffusion control unit 11 and the second diffusion control unit 13 are respectively shapes shown in FIGS. 3 and 4. However, the cross-sectional shapes of the first diffusion control unit 11 and the second diffusion control unit 13 are not limited to these shapes. The cross-sectional shapes of the first diffusion control unit 11 and the second diffusion control unit 13 may have any shape, as long as the sum of a value obtained by dividing a product of an outer peripheral length of the opening portion in the first diffusion control unit 11 and a length in the long side direction of the opening portion in the first diffusion control unit 11, by a cross-sectional area of the opening portion in the first diffusion control unit 11, and a value obtained by dividing a product of an outer peripheral length of the opening portion in the second diffusion control unit 13 and a length in the long side direction of the opening portion in the second diffusion control unit 13, by a cross-sectional area of the opening portion in the second diffusion control unit 13, is 75 or more.

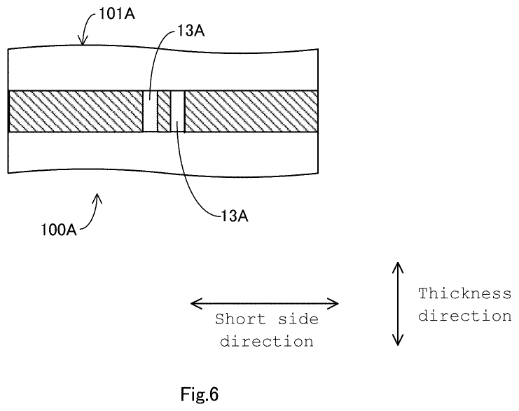

FIG. 6 is a view schematically showing a cross-section of a sensor element 101A according to a first modified example. As shown in FIG. 6, in the sensor element 101A, a second diffusion control unit 13A is constituted by two holes. It is also possible to apply a structure such as that of the second diffusion control unit 13A. Note that, in the second diffusion control unit 13A, the two holes do not have to exactly the same shapes. For example, the length in the short side direction of one of the holes may be longer than that of the other hole.

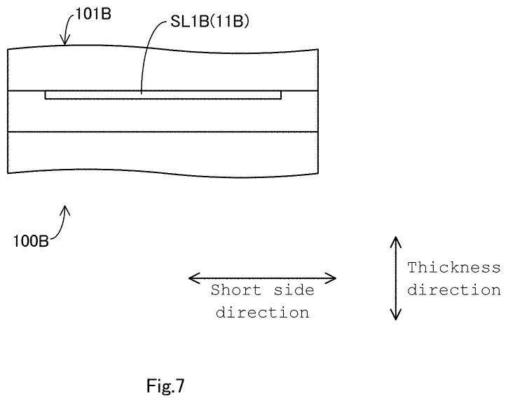

FIG. 7 is a view schematically showing a cross-section of a sensor element 101B according to a second modified example. As shown in FIG. 7, in the sensor element 101B, a first diffusion control unit 11B is constituted by one slit SL1B. It is also possible to apply a structure such as that of the first diffusion control unit 11B.

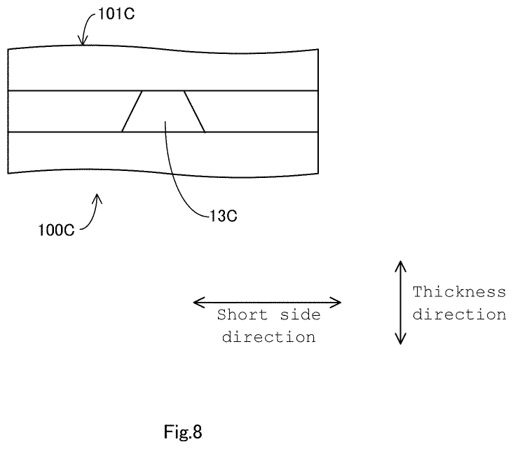

FIG. 8 is a view schematically showing a cross-section of a sensor element 101C according to a third modified example. As shown in FIG. 8, in the sensor element 101C, the cross-sectional shape of the opening portion in a second diffusion control unit 13C is a trapezoidal shape. It is also possible to apply a structure such as that of the second diffusion control unit 13C.

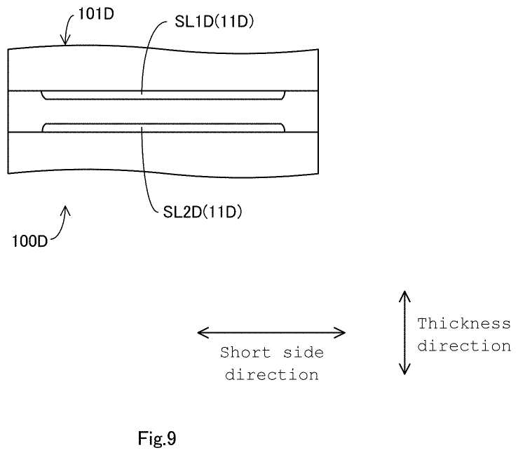

FIG. 9 is a view schematically showing a cross-section of a sensor element 101D according to a fourth modified example. As shown in FIG. 9, in the sensor element 101D, the two end portions in the short side direction of each of slits SL1D and SL2D are curved. It is also possible to apply a structure such as that of a first diffusion control unit 11D. In the case in which the diffusion control unit is constituted by two slits that are arranged in the upper-lower direction (thickness direction) as in the foregoing embodiment and the fourth modified example, the shapes of the slits may be different from each other. For example, the length in the short side direction of one of the slits may be longer than that of the other slit.

5-3

In the sensor element 101 according to the foregoing embodiment, the first diffusion control unit 11 has the slit structure, and the second diffusion control unit 13 has the punched structure. However, the structures of the first diffusion control unit 11 and the second diffusion control unit 13 are not limited to these structures. The first diffusion control unit 11 and the second diffusion control unit 13 may have any structure, as long as the sum of a value obtained by dividing a product of an outer peripheral length of the opening portion in the first diffusion control unit 11 and a length in the long side direction of the opening portion in the first diffusion control unit 11, by a cross-sectional area of the opening portion in the first diffusion control unit 11, and a value obtained by dividing a product of an outer peripheral length of the opening portion in the second diffusion control unit 13 and a length in the long side direction of the opening portion in the second diffusion control unit 13, by a cross-sectional area of the opening portion in the second diffusion control unit 13, is 75 or more. For example, both of the first diffusion control unit 11 and the second diffusion control unit 13 may have the slit structure, or the first diffusion control unit 11 has the punched structure and the second diffusion control unit 13 has the slit structure. For example, in the case in which the first diffusion control unit 11 has the punched structure and the second diffusion control unit 13 has the slit structure, a value obtained by dividing a product of an outer peripheral length of the opening portion in the first diffusion control unit 11 and a length in the long side direction of the opening portion in the first diffusion control unit 11, by a product of an outer peripheral length of the opening portion in the second diffusion control unit 13 and a length in the long side direction of the opening portion in the second diffusion control unit 13 may be smaller than 0.1.

### 6. Examples, etc.

### 6-1. Examples and Comparative Example

### EXAMPLE 1

First, a sensor element 101 representing Example 1 was produced using a method, which will be described below.

Six unfired ceramic green sheets each containing an oxygen ion-conductive solid electrolyte such as zirconia as a ceramic component were prepared. Note that each of the ceramic green sheets was formed through tape casting of a mixture of zirconia particles to which 4 mol % of yttria serving as a stabilizer was added, an organic binder, and an organic solvent. A plurality of sheet holes for use in positioning during printing or stacking, necessary through-holes, and the like were formed through the green sheets.

Furthermore, a space for use as the gas flow passage was formed in advance through punching through a green sheet for use as the spacer layer 5. The second diffusion control unit 13 and the third diffusion control unit 30 were also formed through punching. Then, pattern printing and drying for forming various patterns were performed on the ceramic green sheets respectively corresponding to the first substrate layer 1, the second substrate layer 2, the third substrate layer 3, the first solid electrolyte layer 4, the spacer layer 5, and the second solid electrolyte layer 6.

Specifically, the formed patterns were patterns of the above-described electrodes, lead wires connected to the electrodes, the air introduction layer 48, the heater unit 70, and the like. The pattern printing was performed by applying a pattern forming paste prepared according to properties required for the respective patterns that were to be formed, to green sheets using a known screen printing technique. The drying was also performed using a known drying means. When the pattern printing and the drying were ended, printing and drying of a bonding paste for stacking and bonding the green sheets corresponding to the respective layers were performed.

Then, the green sheets on which the bonding paste was formed were positioned using the sheet holes and stacked in a predetermined order, and subjected to pressure bonding in which the sheets were pressure-bonded by application of predetermined temperature and pressure conditions, and thus one stack was formed. The thus obtained stack included a plurality of sensor elements 101. The stack was cut into portions each having the size of a sensor element 101. Then, the cut stack was fired at a predetermined firing temperature, and thus a sensor element 101 was obtained. Note that, in the sensor element 101, the first diffusion control unit 11 had the slit structure, and the second diffusion control unit 13 had the punched structure.

### EXAMPLES 2 TO 4

Sensor elements representing Examples 2 to 4 were different from the sensor element representing Example 1 only in terms of the first diffusion control unit 11 and/or the second diffusion control unit 13, and were obtained using substantially the same method as that for the sensor element representing Example 1.

The sensor element representing Example 2 was substantially the same as the sensor element representing Example 1. Example 2 was different from Example 1 only in terms of the length in the long side direction of the second diffusion control unit 13.

The sensor element representing Example 3 was different from Example 1 in that the second diffusion control unit 13 had the slit structure.

The sensor element representing Example 4 was different from Example 1 in that the first diffusion control unit 11 had the punched structure and the second diffusion control unit 13 had the slit structure. Furthermore, the sensor element was different therefrom in terms of the length in the long side direction of the first diffusion control unit 11.

### Comparative Example

A sensor element representing Comparative Example was different from the sensor element representing Example 1 only in terms of the first diffusion control unit 11, and was obtained using substantially the same method as that for the sensor element representing Example 1. In the sensor element representing Comparative Example, the first diffusion control unit 11 had the punched structure. Furthermore, the sensor element representing Comparative Example was different from Example 1 in terms of the length in the long side direction of the first diffusion control unit 11.

Table 1 below shows the dimensions of Examples 1 to 4 and Comparative Example. In Table 1, “D0” represents the first diffusion control unit 11, and “D1” represents the second diffusion control unit 13.

TABLE 1

| | D0 | | | | D1 | | | | D0 + |
|---|---|---|---|---|---|---|---|---|---|
| | Outer peripheral | | | | Outer peripheral | | | | D1 |
| | length of | Length | Cross- | L × | length of | Length | Cross- | L × | L × |
| | cross-section m | L | section S | m/S | cross-section m | L | section S | m/S | m/S |
| Ex. 3 | 10.04 | 0.30 | 0.045 | 67 | 10.04 | 0.50 | 0.045 | 112 | 178 |
| Ex. 4 | 0.40 | 0.50 | 0.010 | 20 | 10.04 | 0.50 | 0.045 | 112 | 132 |
| Com. Ex. | 0.40 | 0.50 | 0.010 | 20 | 0.40 | 0.50 | 0.010 | 20 | 40 |
| Ex. 1 | 10.04 | 0.30 | 0.045 | 67 | 0.40 | 0.50 | 0.010 | 20 | 87 |
| Ex. 2 | 10.04 | 0.30 | 0.045 | 67 | 0.40 | 0.25 | 0.010 | 10 | 77 |

### 6-2. Dynamic Pressure Measurement

Dynamic pressure measurement was performed using gas sensors including the sensor elements of Examples 1 to 4 and Comparative Example.

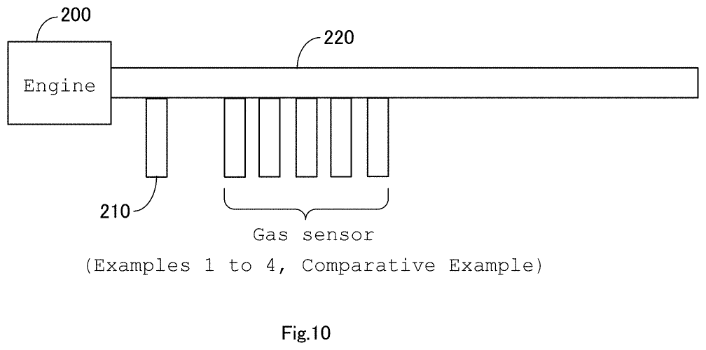

FIG. 10 is a view illustrating a method for measuring the dynamic pressure. As shown in FIG. 10, a pressure gauge 210 and a gas sensor were attached to an exhaust pipe 220 of an engine 200, and dynamic pressure measurement was performed. A 4.6L V8 gasoline engine was used as the engine 200. In the dynamic pressure test, four out of the eight cylinders were operated.

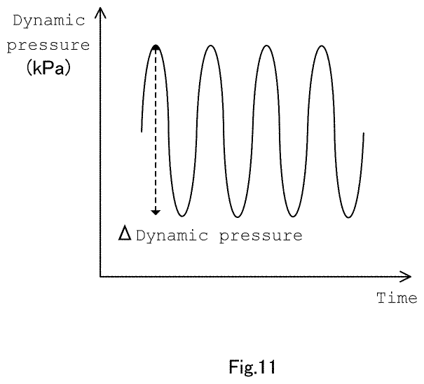

FIG. 11 is a graph schematically showing a state of a dynamic pressure resulting from an operation of the engine 200. As shown in FIG. 11, a dynamic pressure was generated when the engine 200 was operated.

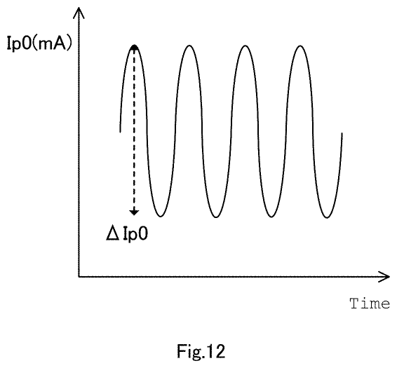

FIG. 12 is a graph schematically showing a change in output Ip0 (FIG. 1) of the gas sensor. Referring to FIG. 12, a change rate of Ip0 (%) was measured in the dynamic pressure measurement. ΔIp0/(Ip0 average) was taken as the change rate of Ip0 (%) . A peak-to-peak value of Ip0 was taken as ΔIp0. The acquisition intervals of a signal indicating Ip0 is 1 msec. A plurality of types of dynamic pressure were generated by adjusting the engine conditions (number of rotations, throttle opening degree, λ), and the change rate of Ip0 at each dynamic pressure was measured. It can be assured that, the smaller the change rate of Ip0 is, the more the dependence on a dynamic pressure is suppressed.

### 6-3. Measurement Result

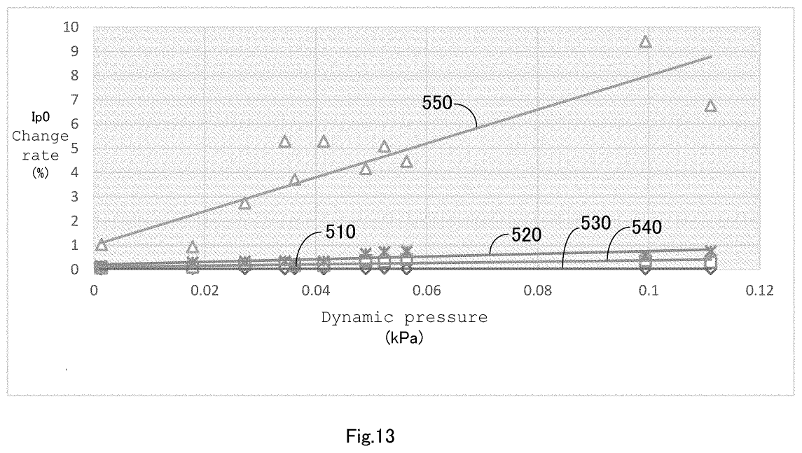

FIG. 13 is a graph showing change rates of Ip0 in Examples 1 to 4 and Comparative Example. Referring to FIG. 13, straight lines 510, 520, 530, and 540 respectively show straight lines obtained by linearly approximating the change rate of Ip0 in Examples 1, 2, 3, and 4. A straight line 550 shows a straight line obtained by linearly approximating the change rate of Ip0 in Comparative Example.

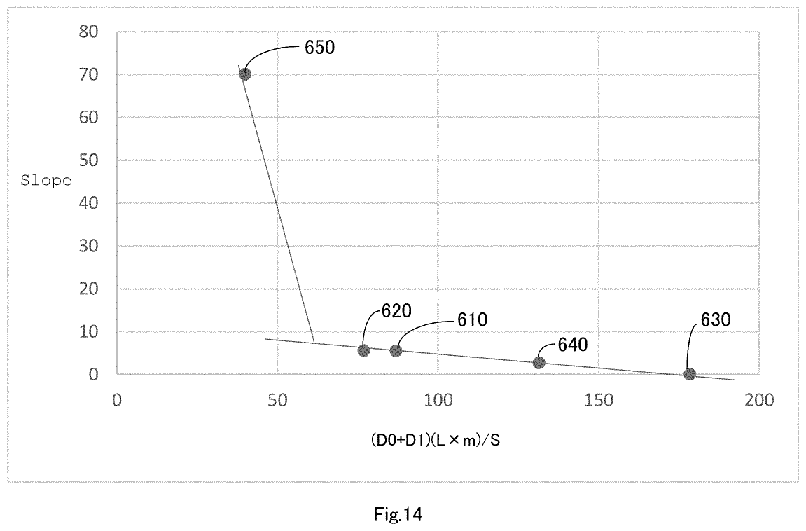

FIG. 14 is a graph showing slopes of straight lines in FIG. 13. Referring to FIG. 14, point 610, 620, 630, and 640 respectively show slopes of the straight line 510, 520, 530, and 540 in FIG. 13. A point 650 shows a slope of the straight line 550 in FIG. 13.

As shown in FIGS. 13 and 14, in Examples 1 to 4, the dependence on a dynamic pressure was significantly suppressed compared with Comparative Example. It is seen from this fact that, if the sum of a value obtained by dividing a product of an outer peripheral length of the opening portion in the first diffusion control unit 11 and a length in the long side direction of the opening portion in the first diffusion control unit 11, by a cross-sectional area of the opening portion in the first diffusion control unit 11, and a value obtained by dividing a product of an outer peripheral length of the opening portion in the second diffusion control unit 13 and a length in the long side direction of the opening portion in the second diffusion control unit 13, by a cross-sectional area of the opening portion in the second diffusion control unit 13, is 75 or more, the dependence on a dynamic pressure is sufficiently suppressed.

### LIST OF REFERENCE NUMERALS

1 First substrate layer
2 Second substrate layer
3 Third substrate layer
4 First solid electrolyte layer
5 Spacer layer
6 Second solid electrolyte layer
10 Gas introduction opening
11 First diffusion control unit
12 Buffer space
13 Second diffusion control unit
20 First internal cavity
21 Main pump cell
22 Internal pump electrode
22a, 51a, 51aX Ceiling electrode portion
22b, 51b, 51bX Bottom electrode portion
23 External pump electrode
30 Third diffusion control unit
40, 40X Second internal cavity
41 Measurement pump cell
42 Reference electrode
43 Reference gas introduction space
44, 44X Measurement electrode
45 Fourth diffusion control unit
46, 52 Variable power source
48 Air introduction layer
50 Auxiliary pump cell
51, 51X Auxiliary pump electrode
60 Fifth diffusion control unit
61 Third internal cavity
70 Heater unit
71 Heater electrode
72 Heater
73 Through-hole
74 Heater insulating layer
75 Pressure dispersing hole
80 Main pump-controlling oxygen partial pressure detection sensor cell
81 Auxiliary pump-controlling oxygen partial pressure detection sensor cell
82 Measurement pump-controlling oxygen partial pressure detection sensor cell
83 Sensor cell
100 Gas sensor
101 Sensor element
200 Engine
210 Pressure gauge
220 Exhaust pipe
510, 520, 530, 540, 550 Straight line
610, 620, 630, 640, 650 Point
SL1, SL2 Slit

What is claimed is:

1. A sensor element for use in measurement of a concentration of a predetermined gas component in a measurement target gas,
wherein the sensor element includes an oxygen ion-conductive solid electrolyte,
the sensor element has a long side and a short side in a plan view,
a gas introduction opening for capturing the measurement target gas from an external space of the sensor element into the sensor element is formed at one end portion in the long side direction of the sensor element,
an internal cavity into which the measurement target gas introduced via the gas introduction opening is introduced is formed inside the sensor element,
a diffusion control unit is formed between the gas introduction opening and the internal cavity,
the diffusion control unit includes first and second diffusion control units that are arranged along the long side direction,
the first diffusion control unit includes a first opening portion,
the second diffusion control unit includes a second opening portion, and
a sum of a value obtained by dividing a product of an outer peripheral length of the first opening portion and a length in the long side direction of the first opening portion, by a cross-sectional area of the first opening portion, and a value obtained by dividing a product of an outer peripheral length of the second opening portion and a length in the long side direction of the second opening portion, by a cross-sectional area of the second opening portion, is 75 or more.

2. The sensor element according to claim 1, comprising a pump cell,
wherein the pump cell includes:
an internal pump electrode formed inside the internal cavity; and
an external pump electrode formed in a space different from the internal cavity, and
the pump cell is configured to pump out oxygen in the internal cavity, by applying a voltage to a point between the internal pump electrode and the external pump electrode.

3. The sensor element according to claim 1, wherein the sum is 180 or less.

4. The sensor element according to claim 1, wherein a shape of the first opening portion and a shape of the second opening portion are different from each other.

5. The sensor element according to claim 4,
wherein one of the first and second opening portions is constituted by two slits that are arranged along a thickness direction of the sensor element,
another of the first and second opening portions is constituted by a hole extending in the long side direction, and
a proportion of a length in the short side direction of the hole to a length in the thickness direction of the hole is 0.3 or more and 2.0 or less.

6. The sensor element according to claim 1, wherein a value obtained by dividing the product of the outer peripheral length of the first opening portion and the length in the long side direction of the first opening portion, by the product of the outer peripheral length of the second opening portion and the length in the long side direction of the second opening portion, is larger than 10 or smaller than 0.1.

7. A gas sensor comprising the sensor element according to claim 1.
